(19) United States
(12) Patent Application Publication
(10) Pub. No.: US 2004/0163505 A1
(43) Pub. Date: Aug. 26, 2004

(54) Tool for gripping

(75) Inventors: Samuel Durham, San Antonio, TX (US); Scott Thompson, Dover, DE (US); Steve Christoffersen, San Antonio, TX (US)

Correspondence Address: MILLEN, WHITE, ZELANO & BRANIGAN, P.C., 2200 CLARENDON BLVD., SUITE 1400, ARLINGTON, VA, 22201, US

(73) Assignee: LOGICOR, LLC, San Antonio, TX

(21) Appl. No.: 10/374,272

(22) Filed: Feb. 26, 2003

(51) Int. Cl. B25B 7/12

(52) U.S. Cl. 81/355

(57) ABSTRACT

One exemplary embodiment of the present invention relates to a tool for gripping, which may include a first member and a second member pivotally coupled at a joint. The joint may at least partially house a first element, a second element, or both the first and second elements.

### FIELD OF THE INVENTION

The present invention generally relates to tools, and particularly for tools for gripping.

### BACKGROUND OF THE INVENTION

In homes and workshops, various types of tools are generally common. These tools can include hand-tools, such as hammers, screwdrivers, pliers, and wrenches. Pliers are often used to grip small objects such as staples, nails, or nuts as well as for bending items such as wire. Wrenches are often used for holding and turning nuts, bolts, or pipes. Although both tools have jaws forming a grip, generally the features of a pliers and a wrench are not combined in a single tool. Consequently, this lack of a combined tool requires the purchase of a separate pliers and a separate wrench. Such duplicity cannot only cost more, but also may occupy more storage space in a workshop or a toolbox. Although there have been attempts in the past to combine the functions of a wrench and a pliers in a single tool, these attempts have generally been unsuccessful for providing a tool with a pliers/wrench dual functionality in a compact form and with an element that easily facilitates switching between a wrench function and a pliers function.

### SUMMARY OF THE INVENTION

One embodiment of the present invention can be a tool for gripping. The tool may include a first member and a second member pivotally coupled at a joint at least partially housing a first element adapted to prevent the expansion of the first or second member in relation to at least a portion of the other member and in a conveniently releasable fashion, a second element adapted to vary a grip of the tool, or both the first and second elements. Desirably, the first element is a detent or a detent mechanism, the second element is a worm or a worm mechanism, and/or the tool is a hand-tool. What is more, the first member can include a handle at one end and a first jaw having a gripping surface at an opposing end. Generally, the tool further includes a second jaw having a gripping surface where the second element may communicate with the second jaw for varying the grip of the tool by permitting the movement of the second jaw while maintaining the gripping surface of the second jaw substantially parallel in relation to the gripping surface of the first jaw. In addition, the tool can include the first element. Moreover, the tool may further include a worm-lock. The worm-lock may include an axle forming a cavity adapted to receive a spring biasing a ball, and the worm having a surface forming a groove terminating in a recess for partially receiving the ball biased by the spring.

Another embodiment of the invention can be a tool for gripping an object. The tool can include a first member including a handle at one end and a first jaw having a gripping surface at an opposing end. The tool may also include a second jaw having a gripping surface where contacting the gripping surface of the first jaw with the gripping surface of the second jaw forms a plurality of openings. Generally, each opening is adapted to correspond with a surface of a head of a mechanical fastener and facilitate the gripping of the mechanical fastener of a size larger than merely displacing the second jaw from the first jaw. What is more, the head of the bolt or the nut may be hexagonal-shaped, each opening may substantially resemble a parallelogram and at least one opening is a different size than the other, and/or only two openings can be formed when the first gripping surface contacts the second gripping surface.

A further embodiment of the present invention may be a hand-tool for gripping an object including a detent mechanism.

Yet another embodiment of the present invention can be a tool for gripping. The tool can include a first member including a handle formed integrally with the frame, which is in turn formed integrally with a first jaw and a second member. Generally, the handle is at one end and the jaw is at the opposing end, which has a gripping surface. The frame can include annuli formed integrally together with a first annulus forming an aperture of a less diameter than an aperture of a second annulus. Also, the second member can form a handle at one end and a frame at the other end where the second member may form a slot at one side of the frame, a first transverse hole at substantially a center of the second member adapted to receive a worm rotatable about an axis, a second hole substantially parallel to the slot, and an opening at a location generally opposing the first handle, and a cavity that communicates with the second hole. Generally, the second hole is adapted to receive a stop, a spring, and a retainer and the cavity is adapted to receive a detent. The tool can also include a second jaw forming a tenon adapted to be received within the slot of a second member and having a second gripping surface where the tenon forms a rack at one end adapted to communicate with the worm. In addition, the tool for gripping may further include a housing including the frame of the first member, the frame of the second member, and a plug. Desirably, the frame of the second member partially inserts into a first side of the frame of the first member and the plug inserts into an opposing side of the first member. Generally, the plug can include a plurality of substantially concentric circular portions diminishing in diameter referenced from an exterior to the interior of the tool.

A still further embodiment of the present invention is a detent mechanism. The detent mechanism may include a first portion having a substantially semi-circular cross-section throughout a part of the length of the first portion and terminating in a stem having a substantially circular cross-section throughout a length of the stem. Generally, the first portion is formed integrally with a second portion having a surface adapted to secure a stop and a third portion formed integrally with the first and second portions and including at least one edge or detent. Moreover, the third portion may further include at least one curved portion. What is more, a tool or hand-tool can include the detent mechanism. Furthermore, the surface of the second portion may form two curved recesses and terminate in a ridge.

Yet another embodiment of the present invention is a tool for gripping. The tool may include a first member and a second member pivotally coupled at a joint that houses a first means adapted to retain the first member in place relative to the second member, and in a conveniently releasable fashion, a second means adapted to vary the grip of the tool, or both the first and second means. Moreover, the tool can include the first means.

A further embodiment of the present invention is a hand-tool that may include a housing adapted to permit the pivoting of a first member in relation to a second member. The housing can include a first substantially ring-shaped member adapted to receive a second generally circular-shaped member in a manner permitting the pivoting of the first member in relation to the second member. Furthermore, the housing can further include a plug. Generally, the plug includes a substantially circular portion formed integrally with a substantially cylindrical portion. The second substantially cylindrical portion may form a recess. Alternatively, the housing generally further includes a plug having a first portion formed integrally with a plurality of tabs that can be biased to secure the plug to the hand-tool.

The tool of the present invention can be designed to be compact in shape, reliable in operation, and durable in use. One particular feature of the present invention is an enlarged pivot point for the first and second members that also serve as a housing for one or more elements that can alter the operation of the tool. Particularly, the enlarged pivot point can house an element to lock in position, or prevent the expansion, of the first and second members in relation to each other for utilizing the tool as a wrench or release the first and second members when using the tool as regular pliers, or expansion or slip joint pliers. In addition, the enlarged joint can house a second element for moving a second jaw while maintaining a gripping surface of the second jaw in a substantially parallel relation to the gripping of the first jaw permitting the tool to be operated as a wrench. Furthermore, at least partially housing both of these elements within the pivot point or joint can help protect these elements from wear and abuse. What is more, the tool of the present invention can form a plurality of openings when the jaws are closed. These openings permit the grasping of objects, such as mechanical fasteners, of a larger size than merely by displacing one of the jaws from the other. Thus, the plurality of openings can increase the capacity of the grip to grasp objects.

### BRIEF DESCRIPTION OF THE DRAWINGS

FIG. 1 is a perspective view from one side of an exemplary tool of the invention.

FIG. 2 is a perspective view of the other side of the exemplary tool of the present invention.

FIG. 3 is an exploded view of an exemplary tool of the present invention.

FIG. 4 is a perspective view of a side of an exemplary second member of the present invention.

FIG. 5 is a perspective view of an exemplary detent of the present invention.

FIG. 5A is an elevational side view of the exemplary detent of the present invention.

FIG. 5B is a cross-sectional view along lines 5B-5B of FIG. 5A of the exemplary detent of the present invention.

FIG. 5C is a view along line 5C-5C in FIG. 5A of the exemplary detent of the present invention.

FIG. 5D is a cross-sectional view along line 5D-5D of FIG. 5A of the exemplary detent of the present invention.

FIG. 6 is a cross-sectional view along line 6, 7, 8, 12-6, 7, 8, 12 in FIG. 1 of the exemplary tool of the present invention depicting the first and second members in open position.

FIG. 7 is a cross-sectional view along line 6, 7, 8, 12-6, 7, 8, 12 in FIG. 1 depicting an exemplary detent of the present invention in an unlocked position.

FIG. 7A is an enlarged view of the exemplary detent of the present invention as depicted in FIG. 7 showing the exemplary detent and an exemplary switch in phantom in an unlocked position.

FIG. 8 is a cross-sectional view along line 6, 7, 8, 12-6, 7, 8, 12 FIG. 1 of the exemplary tool.

FIG. 8A is an enlarged view of an exemplary detent of the present invention from FIG. 8 and an exemplary switch in phantom in a locked position.

FIG. 9 is a side, elevational view of an exemplary worm of the present invention.

FIG. 9A is a cross-sectional view along line 9A-9A of FIG. 9 of the exemplary worm of the present invention.

FIG. 10 is a side, elevational view of another exemplary switch of the present invention.

FIG. 10A is a cross-sectional view along line 10A-10A of FIG. 10 of the exemplary switch of the present invention.

FIG. 11 is a perspective view of another exemplary plug of the present invention.

FIG. 11A is a cross-sectional view along line 11A-11A of FIG. 11 of the exemplary plug of the present invention.

FIG. 12 is an enlarged cross-sectional view along line 6, 7, 8, 12-6, 7, 8, 12 in FIG. 1 depicting another exemplary embodiment of a tool of the present invention including an exemplary worm-lock.

FIG. 13 is a cross-sectional view along line 13-13 of FIG. 12 of the exemplary worm-lock of the present invention.

FIG. 14 is a perspective view of an exemplary bolt.

FIG. 15 is a perspective view of an exemplary nut.

FIG. 16 is a perspective view of a still further exemplary plug of the present invention.

FIG. 16A is a front, elevational view of the still further exemplary plug.

FIG. 16B is a side, elevational view of the still further exemplary plug.

FIG. 17 is a side, elevational view of another embodiment of a tool of the present invention.

As used herein, the term “coupling” means connecting or fastening at least two items directly or indirectly by use of a third component such as a mechanical fastener, e.g. a screw, a nail, a staple, or a rivet; an adhesive or a solder. The term “coupling” can also include associating or forming integrally together items either by chemical or mechanical means, by processes including stamping, molding, or welding. Furthermore, the term “coupled” can mean two items, directly or indirectly, joined, fastened, associated, connected, or formed integrally together.

As used herein, the terms “locking” and “retaining”, with respect to the first and second members in relation to each other, include partially “locking” or “retaining” to prevent the compression but permitting the separation, or the expansion but permitting the bringing together of one or both of the first and second members in relation to at least a portion of the other. The terms “locking” and “retaining” also mean fixing the position of the first and second members in relation to each other, i.e. not permitting their expansion or compression with respect to one another.

As used herein, the term “detent mechanism” means a part comprising a detent and at least one other element.

As used herein, the term “worm mechanism” means a part comprising a worm and at least one other element.

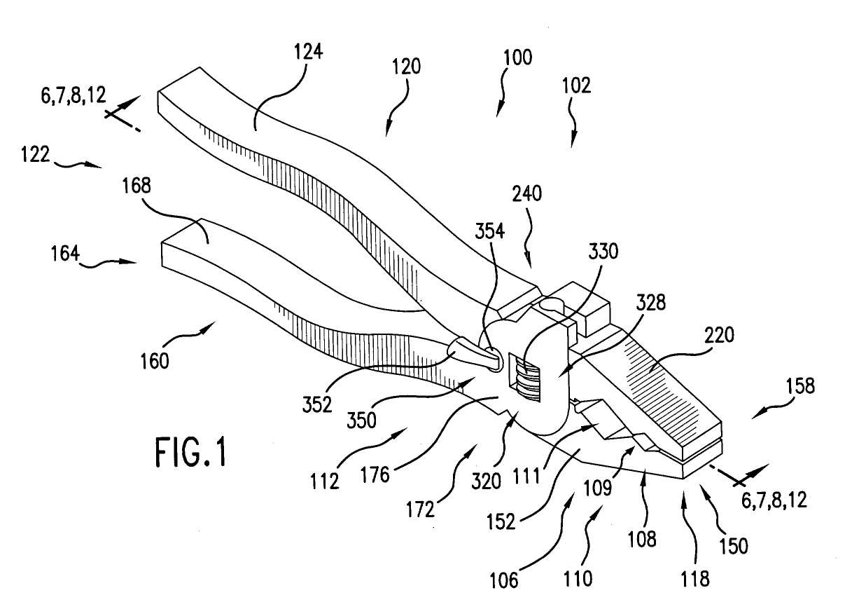

Referring to FIGS. 1-3, one desirable embodiment of the present invention is a tool 100, preferably a hand-tool 102. Although the hand-tool 102 is preferred, it should be understood that the present invention can be modified and/or enlarged to be operated by a machine, such as a demolition clamp used for tearing down buildings. The hand-tool 102 generally has an exterior 112 and an interior 114, and one end 122 and an opposing end 150. The hand-tool 102 can include a first member 120 and a second member 160. The first member 120 generally has a handle 124 at the one end 122 and a first jaw 152 with a gripping surface 154, which generally may be smooth, or alternatively, form teeth to enhance gripping, at the opposing end 150. Generally, the handle 124 and the first jaw 152 are integrally formed with a frame or a first substantially ringed-shaped member 130.

The frame 130 can include an annuli 132, which in turn, generally includes a first annulus 134 and a second annulus 140. Desirably, the first annulus 134 has an aperture 136 having a diameter 138 less than a diameter 143 of an aperture 142 of the second annulus 140. Moreover, the second annulus 140 also forms a notch 149 for receiving a portion of a detent mechanism 270 as hereinafter described.

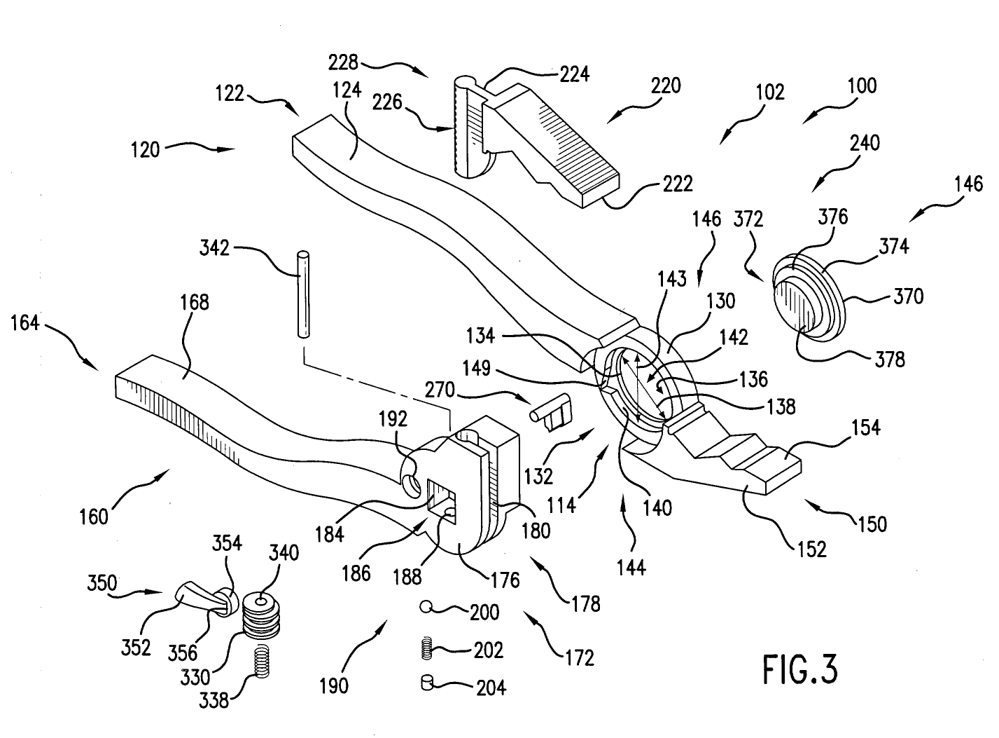

The second member 160 can include a handle 168 at one end 164 and a frame or a second generally circular-shaped member 176 at the other end 172. At one side 178, generally at the front of the hand-tool 102, the frame 176 forms a slot 180. At substantially a center 186 of the frame 176, the frame 176 forms a first transverse hole 184 extending through the frame 176. At one end 164 from the first transverse hole 184, the frame 176 forms a cavity 192. Below the first transverse hole 184 as depicted in FIG. 3, the frame 176 forms a second hole 188 at a location 190 generally opposing the handle 124.

The hand-tool 102 may further include a stop 200, a spring 202, and a retainer 204, adapted to be received within the second hole 188. A portion of the retainer 204 is exposed to an exterior 112 of the hand-tool 102. Referring to FIG. 3, the spring 202 is positioned above the retainer 204, and then in turn, the stop 200 is positioned above the spring 202. Desirably, the stop 200 is ball-shaped.

The hand-tool 102 may also include a second jaw 220 including a rack 226 formed integrally with a tenon 224 at one end 228. The second jaw 220 also includes a gripping surface 222, which generally may be smooth, or alternatively, form teeth to enhance gripping. The first jaw 152 and the second jaw 220 can form a grip 118.

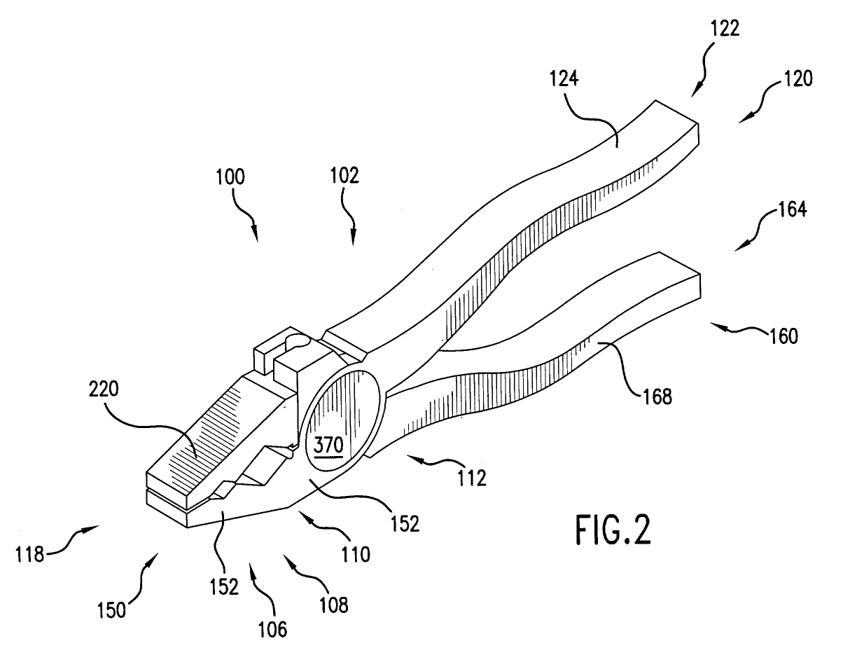

Referring to FIGS. 2-3, the hand-tool 102 may further include a plug 370. The plug 370 can include a plurality of substantially concentric circular portions 372. Generally, the plurality 372 includes a first substantially circular portion 374, formed integrally with a second substantially circular portion 376, which in turn is formed integrally with a third substantially circular portion 378. The plurality of substantially concentric circular portions 372 can diminish in diameter from the exterior 112 to the interior 114 of the hand-tool 102.

Referring to FIGS. 11-11A, another exemplary embodiment of a plug 390 is depicted. The plug 390 generally includes a first substantially circular portion 392 forming a beveled edge 398 formed integrally with a second substantially cylindrical portion 394. The substantially cylindrical portion 394 forms a recess 396, preferably concave. The recess 396 is adapted to provide relief or clearance for a second element or a second means 260 as hereinafter described. When inserted, such as by press-fitting, the plug 370 or 390 can connect to the second member 160 in a fixed manner by friction, so that the plug 370 or 390 and the second member 160 do not move independently of each other. In addition, the plug 390 and the second member 160 retain the first member 120 while permitting its pivoting about a joint 240, hereinafter described.

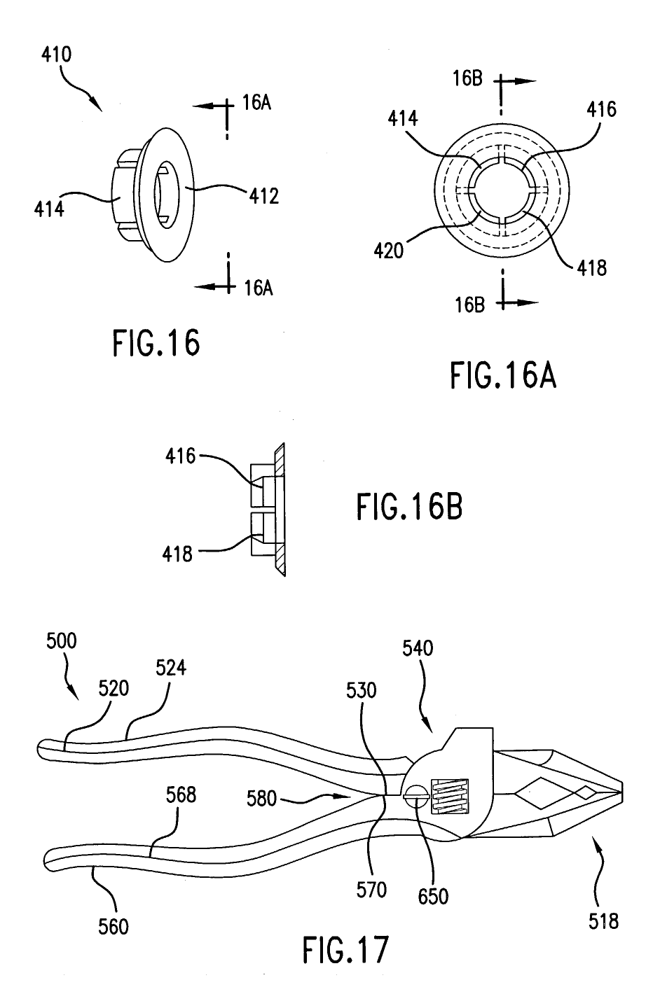

Referring to FIGS. 16A-C, yet another exemplary plug 410 is depicted. The plug 410 forms a first portion 412, preferably ring-shaped, formed integrally with four tabs, namely, a first tab 414, a second tab 416, a third tab 418, and a fourth tab 420. Although four tabs 414, 416, 418, and 420 are depicted, any number of tabs can be used. In one desirable method, the tabs 414, 416, 418, and 420 are inserted into the second member 160. Once inserted the tabs 414, 416, 418, and 420 can be pushed outward with an arbor to secure the plug 410 to the second member 160.

The hand-tool 102 may further include the joint or the housing 240, a first element or a first means 260, and a second element or a second means 320. The joint or housing 240 can include the frame 130, the frame 176, and the plug 370, 390 or 410. Generally, the frame 176 inserts into a first side 144 of the frame 130 and the plug 370 inserts into an opposing side 146 of the frame 130. The joint 240 is generally enlarged to partially house the first element 260 and/or the second element 320. This feature of the present invention can provide some protection to the first element 260 and/or the second element 320. Preferably, both the first element 260 and the second element 320 are at least partially or wholly within the joint 240, although it is contemplated that the joint 240 may only partially house or wholly house the first element 260 or second element 320.

The first element 260 permits the locking of the first member 120 and the second member 160 with respect to each other for use, e.g. as a wrench, and is adapted to release the first member 120 and the second member 160 in a convenient fashion for use of the hand-tool, as, for example, a regular pliers, or slip or expansion joint pliers, such as those sold under the trade designation CHANNEL LOCK pliers by Channel Lock, Inc., 1306 S Main Street, Meadville, Pa. 16335. The first element 260 can be a detent mechanism, a detent, a pawl, a dog, a click, a catch, or a lever.

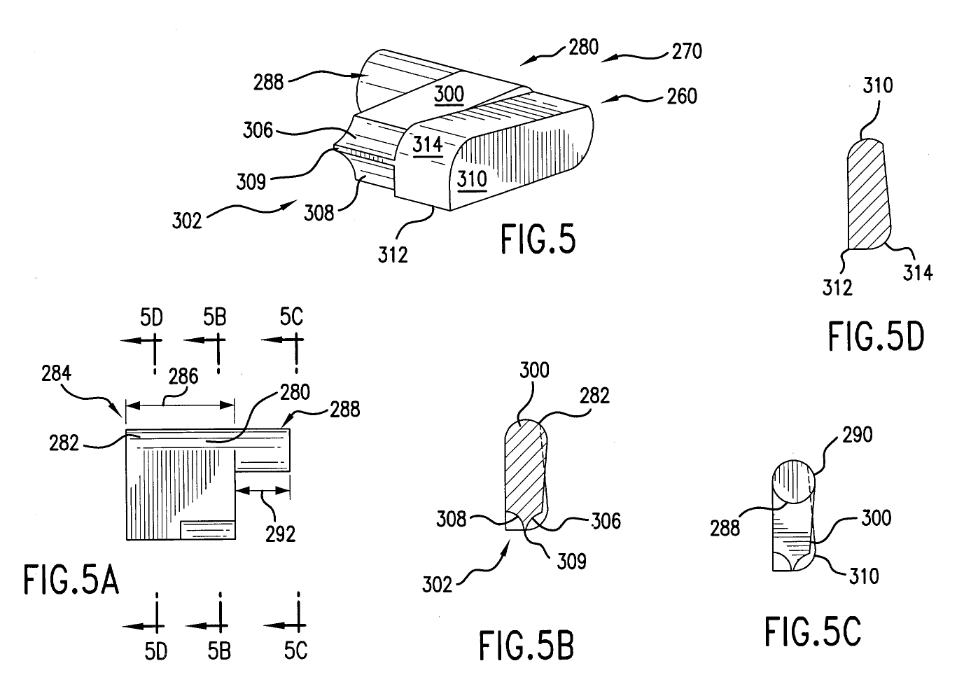

In one preferred embodiment, the first element 260 is a detent mechanism 270. Referring to FIG. 5 and FIGS. 5A-5D, the detent mechanism 270 can include a first portion 280, a second portion 300, and a third portion 310. The first portion 280 can include a substantially semi-circular cross-section 282 along a part 284 of a length 286 of the first portion 280. In addition, the first portion 280 can further include a stem 288 having a substantially circular cross-section 290 throughout a length 292.

The second portion 300 includes a surface 302 adapted to secure a stop. In one preferred embodiment, the surface 302 forms a first curved recess 306 and a second curved recess 308 and terminates in a ridge 309. In another preferred embodiment, the surface 302 can have the same shape as an extrados of an arch, where the arch can be semi-circular, round, lancet, horseshoe, ogee, trefoil, basket-handle, Tudor or pointed. The first curved recess 306 and the second curved recess 308 are adapted to receive the stop 200 as hereinafter described.

The third portion 310 may form at least one edge or detent 312 and a curved portion 314. Generally, the detent 312 is adapted to be received within the notch 149 as hereinafter described. Inserting the detent 312 into the notch 149 prevents expanding a portion of the members 120 and 160, such as at the one end 122, the handles 124 and 168, and/or the opposing end 150, with respect to each other thereby locking them. Generally, when the members 120 and 160 are locked, they are already abutting each other preventing further compression. Thus, even though the inserted detent 312 may not prevent their compression, only their expansion, the members 120 and 160 are generally fixed with respect to each other.

The hand-tool 102 may further include a switch 350 as depicted in FIG. 3. The switch can include a handle 352 formed at one end 356 with a rounded base 354. Alternatively, referring to FIGS. 10 and 10A, another desired embodiment of a switch 450 is depicted. The switch 450 can include a handle 452 formed integrally and centered upon a round base 454. The round base 454 forms a cavity 456. The cavity 456 is adapted to receive the stem 288 of the detent mechanism 270. Similarly, the round base 354 of the switch 350 also forms a recess (not shown) for receiving the stem 288 of the detent mechanism 270.

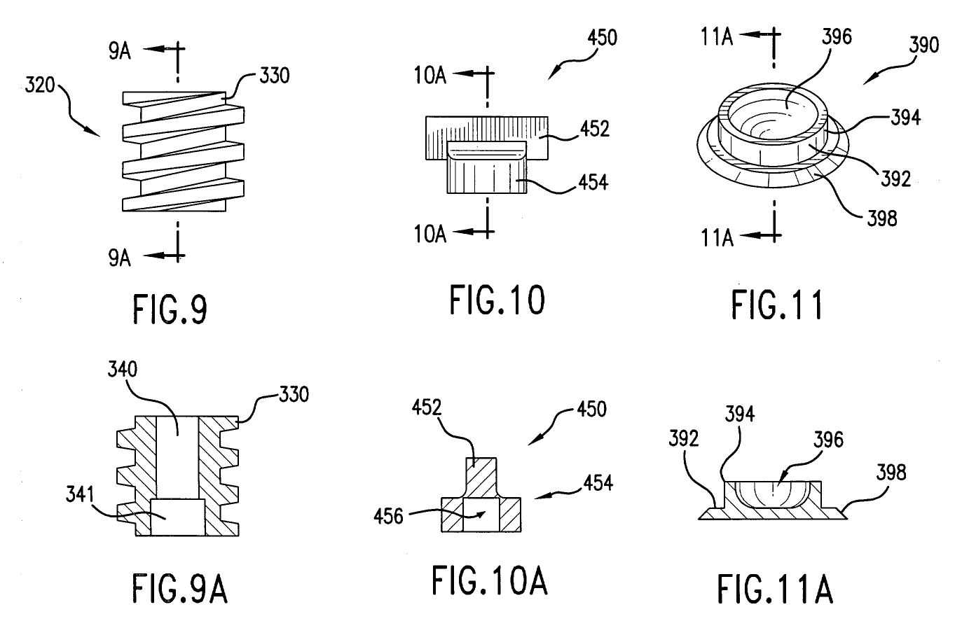

The second element or second means can be a worm or a worm mechanism, such as a worm gear, a worm screw, or a worm and rack. Referring to FIGS. 3 and 9 and FIG. 9A, one preferred embodiment of the second element includes a worm mechanism 328 that may include a worm 330 and an axle 342. The worm forms a void 340 which expands into a hole 341. The void 340 is adapted to receive the axle 342. In addition, the hole 341 is adapted to receive a spring 338 for biasing the worm 330. The worm 330 can rotate about the axle 342.

In one embodiment, the hand-tool 102 can optionally include a worm-lock 360. The worm-lock 360 can include an axle 362 formed integrally with a selector rod 364 at about a 90-degree angle. The worm-lock 360 may also include another embodiment of a worm 430. The worm 430 has an interior surface 432 forming a groove 434 terminating in a recess 436. In addition, the recess 436 extends deeper into the interior surface 432 then the groove 434. The axle 362 further forms a cavity 344 for receiving a spring 346 and a ball 348. The spring 346 biases the ball 348 outward.

Referring to FIG. 1, the jaws 152 and 220 form a plurality of openings 106 when the gripping surface 154 is approximate to or contacting the gripping surface 222. Each of the plurality of openings 106 can be substantially the shape of parallelogram 108, and optionally, a different size 110. In one exemplary embodiment, the plurality of openings 106 include a first opening 109 and a second opening 111. These shapes facilitate the grip 118 of the hand-tool 102 for grasping an object 60 such as a mechanical fastener 62. The mechanical fastener 62 can include a bolt 64 or a nut 72. Optionally, as depicted, the plurality of openings 106 are adapted to correspond to a surface 66 of a head 68 of the bolt 64 or a nut 72, such as a hexagonal shape, respectively, 70 or 78. In addition, the plurality of openings 106 permit the grasping of a larger object 60 than would be permitted merely by the displacement of the second jaw 220 from the first jaw 152. In one exemplary embodiment, a displacement of ⅜ of an inch (0.95 cm), would permit tips 158 of the jaws 152 and 220 to grasp a 1/16 inch (0.16 cm) hexnut, the first opening 109 of the jaws 152 and 220 to grasp a ¼-½ inch (0.64-1.27 cm) hexnut, and the second opening 111 of the jaws 152 and 220 to grasp a ½-3/4 inch (1.27 cm-1.91 cm) hexnut.

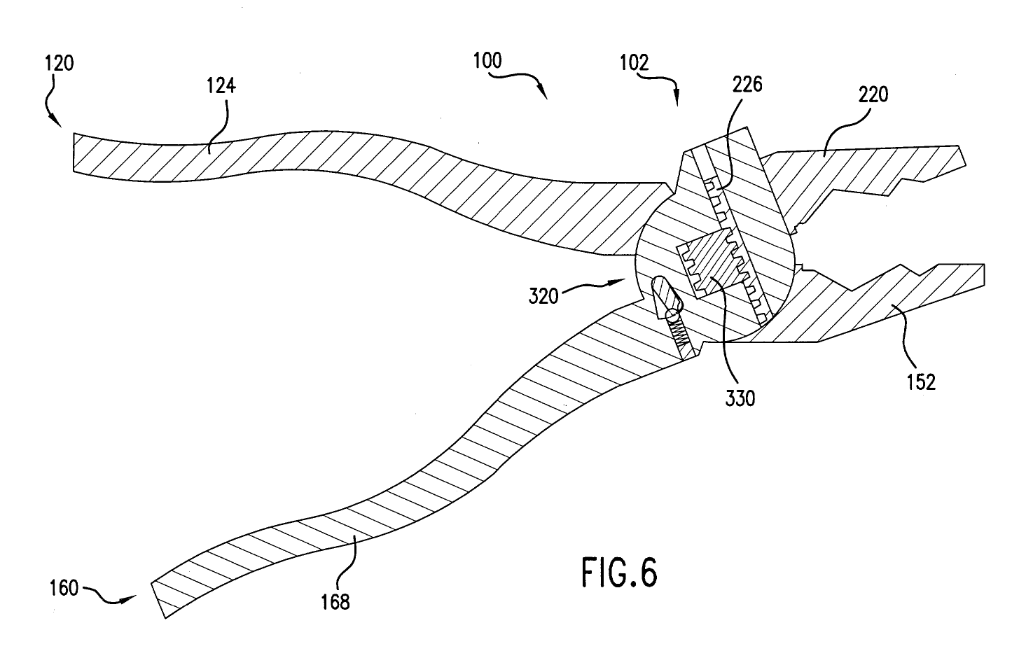

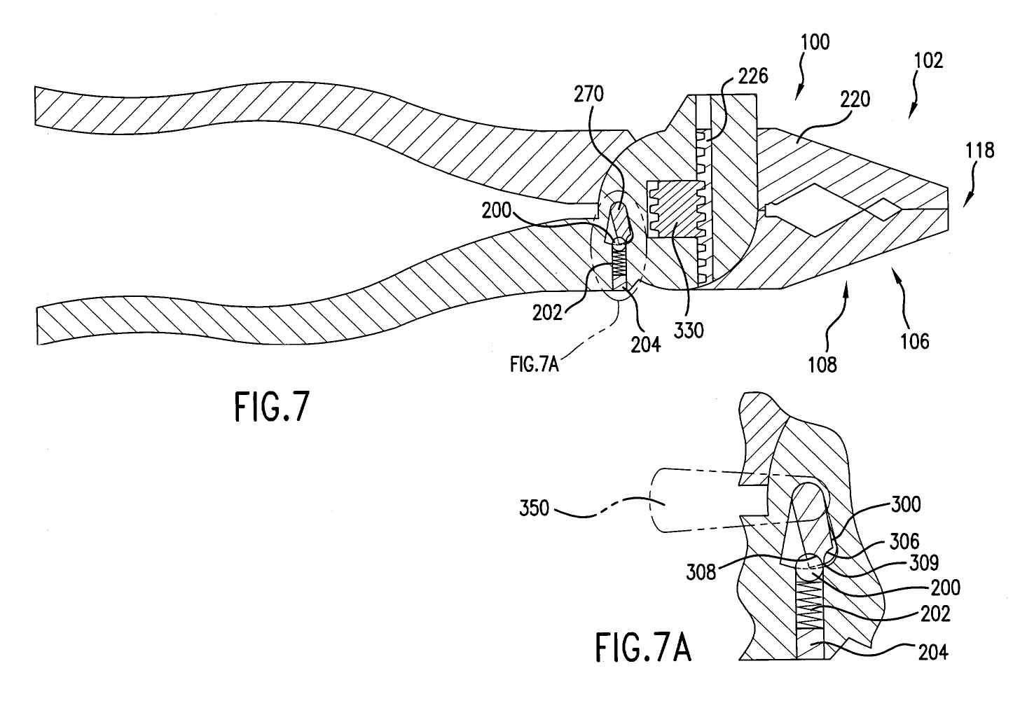

In operation, the tool 100, such as hand-tool 102, can serve as a variety of tools, such as a wrench, a regular pliers, or a slip joint pliers. To operate the hand-tool 102 as pliers, the handle 352 of the switch 350 is positioned generally horizontally as depicted in FIG. 1 and FIG. 7A. This positioning of the handle 352 which is in communication with the stem 288 of the detent mechanism 270, positions the detent mechanism 270 towards the worm 330 as depicted in FIG. 6. This positioning of the detent mechanism 270 permits the stop 200 to reside in the second curved recess 308. Furthermore, the detent 312 of the third portion 310 of the detent mechanism 270 resides outside of the notch 149 of the frame 130 of the first member 120. This permits the opening and closing of the first member 120 and the second member 160. As depicted in FIG. 6, the first member 120 and the second member 160 are in an open position.

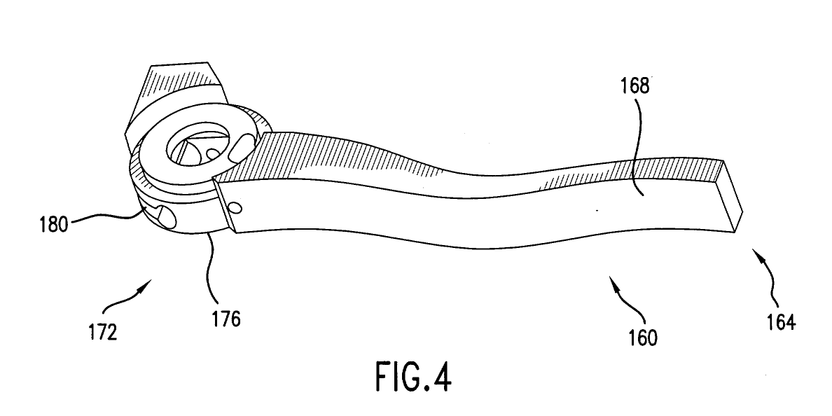

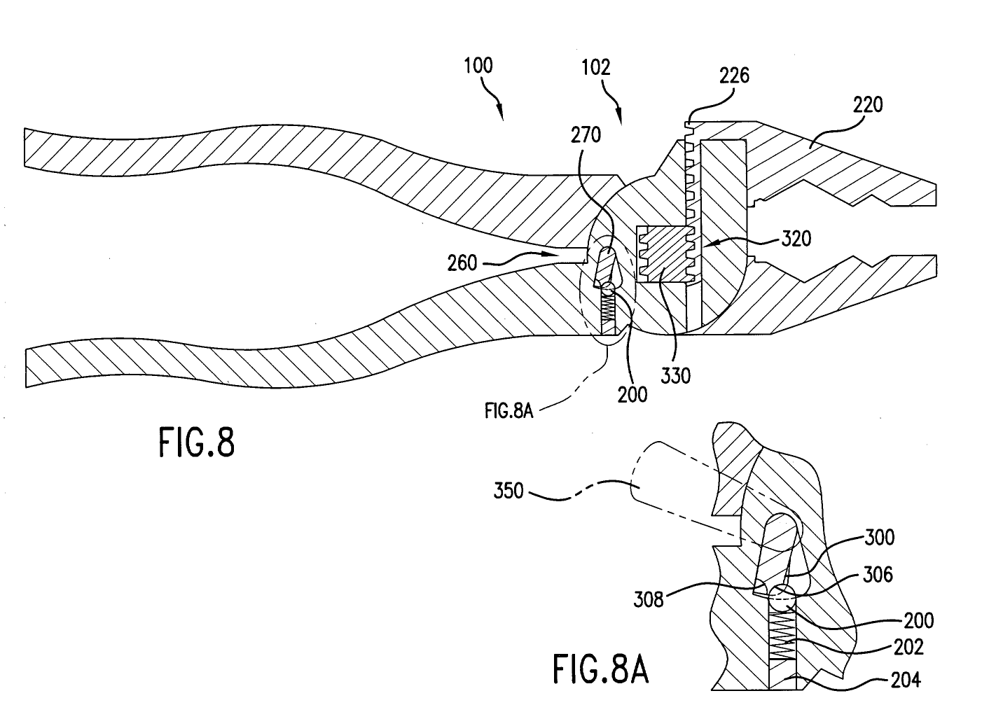

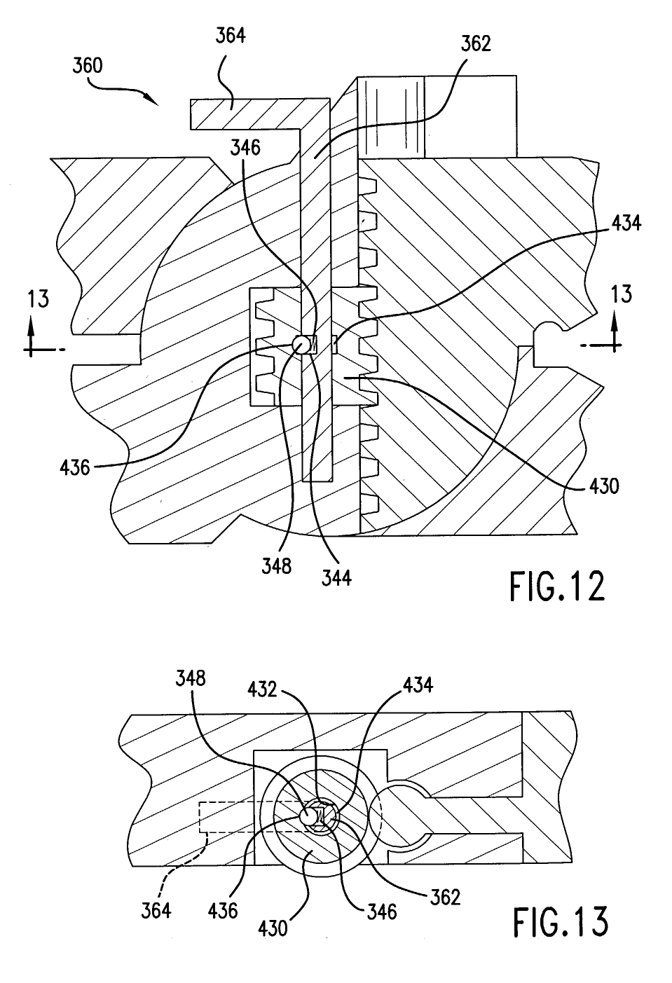

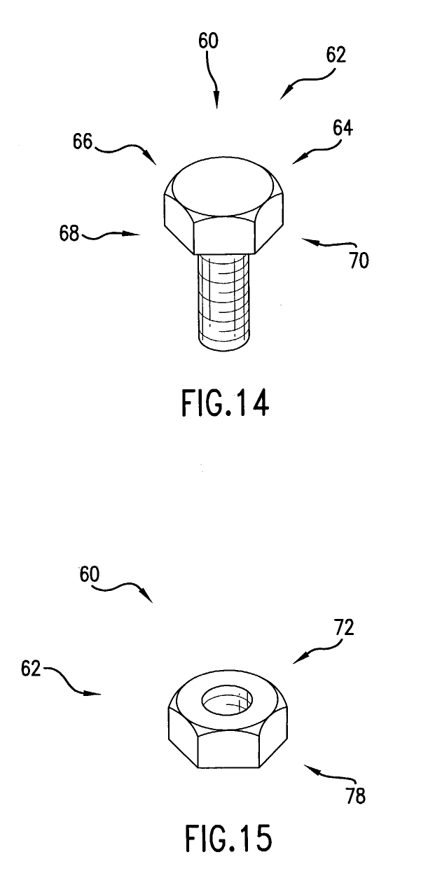

Optionally, the hand-tool 102 may include a worm-lock 360. During use as pliers, it is generally desirable for the second jaw 220 to be fixed. Referring to FIGS. 12 and 13, to prevent inadvertent movement of the worm 430, which communicates with the second jaw 220, the selector rod 364 is rotated resulting in the ball 348 moving from the groove 434 into the recess 436. Thus, the worm 430 cannot easily be rotated, and thus, prevents inadvertent movement of the second jaw 220. When it is desired to move the second jaw 220 in relation to the first jaw 152, the selector rod 364 can be rotated, e.g. 45 degrees, to turn the axle 362 to move the ball 348 from the recess 436 to the groove 434, thereby compressing the spring 346. The ball 348 is now positioned in the groove 434, and the worm 430 can be turned more readily. To operate the hand-tool 102 as a wrench it is generally desirable to have the first member 120 fixed in relation to the second member 160 to prevent the inadvertent expansion of the members 120 and 160. In that manner, the members 120 and 160 are locked to approximate the thickness of a wrench handle. Referring to FIGS. 7, 7A, 8, and 8A, manipulating the switch 350 pivots the detent mechanism 270 away from the worm 330. This permits the stop or ball 200 to slide over the ridge 309 from the second curved recess 308 into the first curved recess 306. The spring 202 secures the ball 200 within the first curve recess 306, preventing inadvertent movement of the detent mechanism 270 which could permit expansion of at least a portion of the first member 120 and the second member 160. Although the locking mechanism of the detent mechanism 270 and the frame 130 forming the notch 149 as depicted in the FIGS. 1-8 prevents the expansion of at least a portion, such as the handles 124 and 168, of respective members 120 and 160, it is contemplated that modifications to the detent mechanism 270 and/or frame 130, such as including a catch, would also prevent the compression of at least a portion of the members 120 and 160, thus completely locking or retaining them. Manipulating the worm 330 permits raising or lowering the second jaw 220 in a substantially parallel relation with respect to its gripping surface 222 and the gripping surface 154 of the first jaw 152.

Referring to FIGS. 8 and 8A, to operate as an expansion joint pliers, rotating the switch 350 counter-clockwise positions the detent mechanism 270 in the open position as discussed above. Manipulating the worm 330 permits moving the second jaw 220 as discussed above, thus permitting the use of the hand-tool 102 as an expansion joint pliers.

Referring to FIG. 17, another embodiment of the present invention is depicted. A tool 500 can include a first member 520 having a handle 524, a second member 560 having a handle 568, a joint or housing 540, and a switch 650. The first member 520 and the second member 560 have portions abutting each other at a location 580 when a grip 518 is closed. This abutment of the first and second members 520 and 560 permits the inclusion of a detent mechanism which only prevents the separation of members 520 and 560. Particularly, the switch can be activated to lock the members 520 and 560 once the grip 528 is closed. Compression of the members 520 and 560 is prevented by the contact of their respective abutting portions 530 and 570. The various components of the tool 100 can be fashioned from a variety of materials such as metal or plastic and manufactured in multiple ways. As an example, the hand-tool 102 can be made from acetal plastic, except for the stop 200, which can be made from chrome-plated carbon steel. Preferably, the hand-tool 102 can be made from at least one metal and/or at least one alloy, such as chrome-vanadium steel. Particularly exemplary, the first member 120, the second member 160, the detent mechanism 270, the plug 370, 390, or 410, the spring 202, the worm 330 or 430, and the axle 342 or 362, can be made of acetal plastic, while the stop or ball 200 can be made from chrome-plated carbon steel. Regarding exemplary manufacturing methods, the axle 342 may be fashioned from a plastic material that can be attached to the worm 330 using any suitable means such as adhesives or be stamped or molded as a single part. Depending on the material, the tool 100 can be formed by such processes as welding, stamping, or molding. In addition, the springs can be made from any suitable material such as stainless steel, which can be obtained from commercially available sources such as the Lee Spring Company of 1462 62^{nd} Street, Brooklyn, N.Y. 11219.

Without further elaboration, it is believed that one skilled in the art can, using the proceeding description, utilize the present invention to its fullest extent. Unless otherwise indicated, all parts and percentages are by weight. The entire disclosure of all cited applications, patents and publications is hereby incorporated by reference.

From the foregoing description, one skilled in the art can easily ascertain the essential characteristics of this invention and, without departing from the spirit and scope thereof, can make various changes and modifications to the invention to adapt it to various usages and conditions.

1. A tool for gripping, comprising:
a first member and a second member pivotally coupled at a joint at least partially housing a first element adapted to prevent the expansion of at least a portion of the first or second member in relation to the other member and in a conveniently releasable fashion, a second element adapted to vary a grip of the tool, or both the first and second elements.

2. A tool according to claim 1, wherein the first element is a detent or a detent mechanism.

3. A tool according to claim 1, wherein the second element is a worm or a worm mechanism.

4. A tool according to claim 1, wherein the tool is a hand-tool.

5. A tool according to claim 1, wherein the first member comprises a handle at one end and a first jaw having a gripping surface at an opposing end and the tool further comprises a second jaw having a gripping surface wherein the second element communicates with the second jaw for varying the grip of the tool by permitting the movement of the second jaw while maintaining the gripping surface of the second jaw substantially parallel in relation to the gripping surface of the first jaw.

6. A tool for gripping an object, comprising:
a first member comprising a handle at one end and a first jaw at an opposing end wherein the first jaw has a gripping surface; and
a second jaw having a gripping surface wherein contacting the gripping surface of the first jaw with the gripping surface of the second jaw forms a plurality of openings wherein each opening is adapted to correspond to a surface of a head of a mechanical fastener and facilitate the gripping of the mechanical fastener of a size larger than merely displacing the second jaw from the first jaw.

7. A tool according to claim 6, wherein the head of the bolt or the nut is hexagonal-shaped.

8. A tool according to claim 6, wherein each opening substantially resembles a parallelogram and at least one opening is a different size than the other.

9. A tool according to claim 6, wherein when the first gripping surface contacts the second gripping surface only two openings are formed.

10. A hand-tool for gripping an object comprising a detent mechanism.

11. A tool for gripping, comprising:
a first member comprising a handle formed integrally with a frame, which is in turn formed integrally with a first jaw wherein the handle is at one end and the first jaw having a gripping surface is at an opposing end, and the frame comprises annuli formed integrally together wherein a first annulus forms an aperture of a less diameter than an aperture of a second annulus; a second member forming a handle at one end and a frame at the other end wherein the second member forms a slot at one side of the frame, a first traverse hole at substantially a center of the frame of the second member adapted to receive a worm rotatable about an axle, a second hole substantially parallel to the slot and opening at location generally opposing the first handle, and a cavity which communicates with the second hole wherein the second hole is adapted to receive a stop, a spring, and a retainer and the cavity is adapted to receive a detent;
a second jaw forming a tenon adapted to be received within the slot of the second member and having a second gripping surface wherein the tenon at one end forms a rack adapted to communicate with the worm; and
a housing comprising the frame of the first member, the frame of the second member, and a plug wherein the frame of the second member partially inserts into a first side of the frame of the first member and the plug inserts into an opposing side of the frame of the first member wherein the plug comprises a plurality of substantially concentric circular portions diminishing in diameter referenced from an exterior to an interior of the tool.

12. A detent mechanism comprising:
a first portion having a substantially semi-circular cross-section throughout a part of a length of the first portion and terminating in a stem having a substantially circular cross-section throughout a length of the stem wherein the first portion is formed integrally with:
a second portion having a surface adapted to secure a stop; and
a third portion formed integrally with the first and second portions and comprises at least one edge.

13. A detent mechanism according to claim 12, wherein the third portion further comprises at least one curved portion.

14. A tool comprising the detent mechanism according to claim 12.

15. A tool according to claim 14, wherein the tool is a hand-tool.

16. A tool for gripping, comprising:
a first member and a second member pivotally coupled at a joint housing, a first means adapted to retain the first member in place relative to the second member and in conveniently releasable fashion, a second means adapted to vary a grip of the tool, or both the first and second means.

17. A hand-tool comprising:
a housing adapted to permit the pivoting of a first member in relation to a second member.

18. A hand-tool according to claim 17, wherein the housing comprises a first substantially ring-shaped member adapted to receive a second generally circular-shaped member in a manner permitting the pivoting of the first member in relation to the second member.

19. A hand-tool according to claim 18, wherein the housing further comprises a plug, comprising:
a substantially circular portion formed integrally with a substantially cylindrical portion wherein the second substantially cylindrical portion forms a recess.

20. A tool according to claim 1, comprising the first element.

21. A tool according to claim 16, comprising the first means.

22. A tool according to claim 3, further comprising a worm-lock, wherein the worm-lock comprises:
an axle forming a cavity adapted to receive a spring biasing a ball; and
the worm comprising a surface forming a groove terminating in a recess for partially receiving the ball biased by the spring.

23. A detent mechanism according to claim 12, wherein the surface of the second portion forms two curved recesses and terminates in a ridge.

24. A hand-tool according to claim 18, wherein the housing further comprises a plug, comprising:
a first portion formed integrally with a plurality of tabs which can be biased to secure the plug to the hand-tool.
